(19) United States
(12) Patent Application Publication
(10) Pub. No.: US 2026/0299316 A1
(43) Pub. Date: Oct. 1, 2026

(54) EYEGLASSES

(71) Applicant: Raptor Sports Pty Ltd, Gilston (AU)

(72) Inventor: Craig Leach, Gilston (AU)

(21) Appl. No.: 19/635,089

(22) Filed: Mar. 31, 2026

(30) Foreign Application Priority Data
Mar. 31, 2025 (AU) 2025901083

(51) Int. Cl. G02C 7/04

(52) U.S. Cl. CPC G02C 7/049

(57) ABSTRACT

A lens, the lens being at least partially fabricated from a composite material comprising a plurality of boron nitride structures dispersed within a base material, the boron nitride structures comprising one or more forms of crystalline boron nitride structures.

### TECHNICAL FIELD

The present invention relates to improvements in eyeglasses. In particular, the present invention relates to improvements in the mechanical properties of lenses and frames, and in particular those used in eyeglasses and sunglasses.

### BACKGROUND

Eyeglasses (or simply “glasses”) are vision eyewear with clear or tinted lenses mounted in a frame that holds the lenses in front of a wearer's eyes. Glasses are often used for vision correction, although may also be used for cosmetic purposes without the use of specialised lenses.

In addition, glasses may be used for eye protection. For instance, safety glasses may protect a wearer against flying debris (such as for construction workers, laboratory technicians or in some sports), while sunglasses allow for better vision in bright daylight and are used to protect a wearer's eyes against damage from excessive levels of ultraviolet light.

The lenses in a pair of glasses may be fabricated from glass or a polymeric material, such as polycarbonate. These materials are prone to damage from scratching or scuffing, which can lead over time to a decline in both the effectiveness of the lenses (if used for vision correction) and/or the aesthetic appeal of the glasses.

Some attempts have been made to overcome this issue. For instance, protective coatings may be applied to lenses in order to reduce damage and extend the life of the lenses. While these protective coatings may be of some use in protecting lenses from damage in everyday settings, they are unlikely to prevent serious damage to the lenses if, for instance, the glasses come into contact with an abrasive surface (such as being dropped on concrete or gravel).

Thus, there would be an advantage if it were possible to provide lenses that provided enhanced resistance to damage.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a lens, which may at least partially address one or more of the problems or deficiencies mentioned above or which may provide the public with a useful or commercial choice.

With the foregoing in view, the present invention in one form, resides broadly in a lens, the lens being at least partially fabricated from a composite material comprising a plurality of boron nitride structures dispersed within a base material, the boron nitride structures comprising one or more forms of crystalline boron nitride structures.

The lens may be of any suitable form, and may be used for any suitable purpose. For instance, in some embodiments of the invention, the lens may comprise an eyeglass lens (i.e., a lens configured to be located and retained in an eyeglass frame). The eyeglass lens may be used for vision correction and/or eye protection. It will be understood that the term “eye protection” as used herein is intended to refer to any function of the eyeglass lens that may protect the wearer's eye, such as protection from debris or chemicals, sports equipment (such as balls, and in particular squash balls) or from ultraviolet light. Thus, it is envisaged that the eyeglass lens of the present invention may be used in any suitable eyeglasses, such as eyeglasses for vision correction, safety glasses, sunglasses and so on.

In other embodiments of the invention, the lens may comprise a contact lens. The contact lens may be a soft lens (such as those manufactured from relatively soft polymeric materials, such as hydrogel or silicon hydrogel) or a hard lens (such as those manufactured from relative hard materials, such as silicone polymers).

As stated, the lens is at least partially fabricated from a composite material. Any suitable portion of the lens may be fabricated from the composite material. In some embodiments, the lens may be partially fabricated from glass or a polymeric material (such as polycarbonate, polyurethane or urethane-based prepolymer or similar optical material, acrylic or the like). It is envisaged that the portions of the lens fabricated from glass or a polymeric material may be, for instance, specially shaped portions of the lens for vision correction. In this embodiment, the use of the composite material for these portions of the lens may be unsuitable. Thus, in this embodiment of the invention, the composite material may be applied as a coating to a surface of a base layer. Preferably, the base layer may be at least partially fabricated from glass or a polymeric material (such as polycarbonate, polyurethane or urethane-based prepolymer or similar optical material, acrylic or the like).

More preferably, however, the entire lens may be fabricated from the composite material.

The base material may be of any suitable form. Preferably, however, the base material may comprise glass, a polymeric material, or a combination thereof. Any suitable polymeric material may be used for the base material, such as acrylic, polyethylene or the like. In a preferred embodiment of the invention, the polymeric material may comprise polycarbonate, polyurethane or urethane-based prepolymer or similar optical material. In the case of contact lenses, the base material may comprise hydrogel, silicone hydrogel or a relatively rigid silicone polymer.

The composite material may comprise any suitable weight percent boron nitride structures. For instance, the composite material may comprise between about 0.001 wt % and about 60 wt % boron nitride structures. More preferably, the composite material may comprise between about 0.002 wt % and about 55 wt % boron nitride structures. Still more preferably, the composite material may comprise between about 0.003 wt % and about 50 wt % boron nitride structures. Yet more preferably, the composite material may comprise between about 0.004 wt % and about 30 wt % boron nitride structures. Even more preferably, the composite material may comprise between about 0.005 wt % and about 20 wt % boron nitride structures. Still more preferably the composite material may comprise between about 0.008 wt % and about 10 wt % boron nitride structures. More preferably, the composite material may comprise between about 0.01 wt % and about 5 wt % boron nitride structures. More preferably, the composite material may comprise between about 0.05 wt % and about 2 wt % boron nitride structures. More preferably, the composite material may comprise between about 0.1 wt % and about 1 wt % boron nitride structures.

It is envisaged that, at relatively low concentrations of the boron nitride structures (i.e., no more than about 10 wt % boron nitride structures), the composite material is configured to provide relatively high optical clarity. Preferably, when the concentration of the boron nitride structures in the composite material is no more than 10 wt %, the lens may exhibit a visible light transmittance of at least 90%. More preferably, when the concentration of the boron nitride structures in the composite material is no more than wt %, the lens may exhibit a visible light transmittance of at least 95%. More preferably, when the concentration of the boron nitride structures in the composite material is no more than 10 wt %, the lens may exhibit a visible light transmittance of at least 98%.

Preferably, the lens of the present invention exhibits relatively low optical haze. Preferably, the optical haze is less than 2%. More preferably, the optical haze is less than 1%. More preferably, the optical haze is less than 0.5%.

It is envisaged that, at relatively low concentrations of the boron nitride structures (i.e., no more than about 10 wt % boron nitride structures) and with substantially homogenous distribution of the boron nitride structures within the composite material, light scattering within the composite material is reduced in comparison to conventional lenses. It is envisaged that the boron nitride structures may be substantially transparent in the visible light spectrum and are dispersed substantially homogenously throughout the composite material such that they do not significantly scatter visible light.

In addition, the applicant has surprisingly found that the additional of boron nitride structures results in an increase in the refractive index of the composite material in comparison to conventional lenses.

Typically, the refractive index of conventional lenses varies from between about 1.50 for standard plastic lenses and 1.74 for thin plastic lenses. It is envisaged that the refractive index of the lenses of the present invention may be increased by at least 0.005, and more preferably between about 0.01 and 0.03 for comparable conventional lenses.

This increase in the refractive index means that a lens fabricated using the composite material of the present invention may be thinner than a conventional lens for a given optical prescription.

It is envisaged that the boron nitride structures may be impregnated within the matrix material. Thus, in embodiments in which the lens consists of the composite material, it is envisaged that the boron nitride structures may be dispersed throughout the entire lens. Preferably, the boron nitride structures may be substantially homogeneously dispersed throughout the entire lens.

The term “crystalline boron nitride structures” as used herein is intended to refer to non-amorphous forms of boron nitride. More specifically, the term is intended to refer to crystalline structures that consist of a single layer or multiple layers of boron nitride. The term “crystalline boron nitride structures” as used herein and, unless otherwise qualified, is intended to encompass forms of crystalline boron nitride such as boron nitride nanotubes, boron nitride ribbon, boron nitride wire, boron nitride sheets, boron nitride nanosheets, boron nitride nano wire, boron nitride nano ribbon, or any combination thereof. The crystalline boron nitride structures may comprise a single crystalline form of boron nitride. Alternatively, the crystalline boron nitride structures may comprise two or more forms of crystalline boron nitride.

In a preferred embodiment of the invention, the boron nitride structures comprise boron nitride nanostructures.

Preferably, when two or more forms of crystalline boron nitride structures are present, the two or more crystalline forms may comprise a combination of boron nitride nanotubes, boron nitride wire, boron nitride ribbon and/or boron nitride nanosheets. The various crystalline boron nitride structures may be present in any suitable concentration. For instance, equal amounts (by weight or by volume) of each of the boron nitride structures may be provided. Alternatively, each form of boron nitride structure may comprise between 0.1% and 99.9% (by weight or by volume) of the total quantity of crystalline boron nitride structures. More preferably, each form of boron nitride structure may comprise between 10% and 90% (by weight or by volume) of the total quantity of crystalline boron nitride structures. More preferably, each form of boron nitride structure may comprise between 20% and 80% (by weight or by volume) of the total quantity of crystalline boron nitride structures. More preferably, each form of boron nitride structure may comprise between 30% and 70% (by weight or by volume) of the total quantity of crystalline boron nitride structures. More preferably, each form of boron nitride structure may comprise between 40% and 60% (by weight or by volume) of the total quantity of crystalline boron nitride structures

In some embodiments of the invention, the two or more forms of crystalline boron nitride structures may comprise boron nitride nanotubes and boron nitride wire, or boron nitride nanotubes and boron nitride ribbon, or boron nitride nanotubes and boron nitride nanosheets, or boron nitride wire and boron nitride ribbon, or boron nitride wire and boron nitride nanosheets, or boron nitride ribbon and boron nitride nanosheets. In some embodiments of the invention, the crystalline boron nitride structures may comprise any combination of three of boron nitride nanotubes, boron nitride wire, boron nitride ribbon and/or boron nitride nanosheets. In some embodiments, the crystalline boron nitride structures may comprise all four of boron nitride nanotubes, boron nitride wire, boron nitride ribbon and/or boron nitride nanosheets.

It is envisaged that the composite material may be formed by introducing the boron nitride structures to a molten or liquid form of the base material. Preferably, the boron nitride structures may be substantially homogenously distributed within the base material, such as by agitating the base material or the like.

In some embodiments, the composite material may be cast or moulded into the shape of the lens. In other embodiments, once formed, the lens may be shaped (such as by grinding) to provide the desired vision correction properties.

One or more additional substances may be added to the composite material. For instance, one or more pigments, clarifiers, ultraviolet or infrared absorbers or the like, or any suitable combination thereof.

In some embodiments, one or more coating layers may be applied to the lens. The coating layers may be of any suitable form and used for any suitable purpose. In some embodiments, the one or more coating layers may include anti-reflective coatings, blue light coatings, ultraviolet protective coatings, scratch-resistant coatings, mirror coatings, hydrophobic coatings, oleophobic coatings, photochromatic coatings, polarised coatings and the like.

In some embodiments of the invention, one or more layers of coating may be fabricated from the same composite material as the lens.

It is envisaged that the coating layer may provide improved wear resistance compared to an equivalent optical coating in which boron nitride structures are not present. Preferably, the wear resistance of the coating layer of the present invention is at least 20% greater than an equivalent optical coating in which boron nitride structures are not present. Preferably, the wear resistance of the coating layer of the present invention is at least 30% greater than an equivalent optical coating in which boron nitride structures are not present. Preferably, the wear resistance of the coating layer of the present invention is at least 40% greater than an equivalent optical coating in which boron nitride structures are not present.

In some embodiments, the coating layer of the present invention may exhibit reduced micro-scratch formation under abrasive condition. Further, the coating layer of the present invention may exhibit hydrophobic and/or oleophobic properties, resulting in improved cleanability and reduced smudging.

In some embodiments, the lens may be fabricated from the composite material, and one or more layers comprising the composite material may be applied to the lens.

The lens may be of any suitable size or shape, and it will be understood that the size and shape may depend on a number of factors, such as the purpose of the lens (i.e., whether the lens is to be used for vision correction, in safety glasses, in sunglasses, or as a contact lens), the size and shape of the frame in which the lens is to be used and so on. The size (including the thickness) of the lens may be determined by the prescription of the wearer when the lens is used for vision correction.

In some embodiments of the invention, the lens may be shaped so as to be received in eyeglass frames. For instance, the lens may be provided with shaped edges (i.e., bevels, chamfers or the like) configured to be received and retained in eyeglass frames.

In some embodiments, the lens may be provided with one or more apertures therein. The apertures may be of any suitable size, shape or location. The apertures may be configured to allow a fastener (such as a mechanical fastener, including a screw, bolt, nail or the like) to pass at least partially therethrough and secure the lens to an eyeglass frame.

Through the addition of the boron nitride structures, it is envisaged that the lens of the present invention may be provided with improved mechanical strength, impact resistance and scratch resistant over conventional eyeglass lenses or contact lenses. Further, it is envisaged that the lens of the present invention may be relatively lightweight in comparison to conventional eyeglass lenses and contact lenses.

As previously stated, the lens of the present invention may be configured to be retained within an eyeglass frame.

In some embodiments, it is envisaged that at least a portion of the eyeglass frame in which the lens is retained may be fabricated from the same material as the lens. Thus, in a second aspect, the invention resides broadly in an eyeglass frame, the eyeglass frame being at least partially fabricated from a composite material comprising a plurality of boron nitride structures dispersed within a base material, the boron nitride structures comprising one or more forms of crystalline boron nitride structures.

Any suitable portion of the eyeglass frame may be fabricated from the composite material. For instance, one or more of the rims, bridge, endpieces, temples and temple tips may be fabricated from the composite material.

Preferably, the eyeglass frame is configured to include one or more lenses. In embodiments of the invention in which the rims are fabricated from the composite materials, it is envisaged that the one or more lenses and the rims may be formed integrally with one another. Alternatively, the one or more lenses may be formed separately to the rims and configured for connection thereto.

In some embodiments, one or more coating layers may be applied to the eyeglass frames. The coating layers may be of any suitable form and used for any suitable purpose. In some embodiments, the one or more coating layers may include scratch-resistant coatings, UV-resistant coatings, hydrophobic coatings, oleophobic coatings, and the like.

In some embodiments of the invention, one or more layers of coating may be fabricated from the same composite material as the eyeglass frames.

In some embodiments, the presence of the boron nitride structures may improve the mechanical properties of the eyeglass frame. Specifically, the composite material may exhibit increased toughness and reduced brittleness relative to the equivalent material with no boron nitride structures present.

In some embodiments, the composite material may exhibit improved resistance to crack initiation and propagation.

Without wishing to be bound by theory, it is believed that the boron nitride structures contribute to energy dissipation within the composite material, thereby enhancing elastic deformation and fatigue resistance.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a pair of eyeglasses including eyeglass frames and lenses according to an embodiment of the present invention.

FIG. 2 illustrates a pair of eyeglasses including lenses according to an alternative embodiment of the present invention.

FIG. 3 illustrates contact lenses according to an embodiment of the present invention.

### DETAILED DESCRIPTION

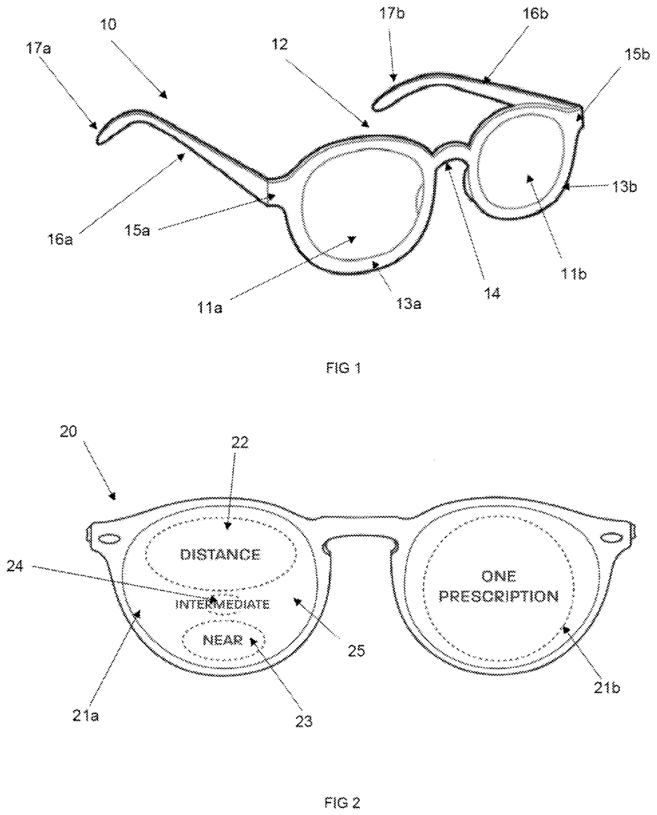

FIG. 1 illustrates a pair of eyeglasses 10 including lenses 11a, 11b and an eyeglass frame 12 according to an embodiment of the present invention. The lenses 11a, 11b are fabricated from a composite material comprising a plurality of boron nitride structures dispersed within a base material, the boron nitride structures comprising one or more forms of crystalline boron nitride structures.

In this embodiment, the base material comprises polycarbonate, while the crystalline boron nitride structures comprise boron nitride nanotubes substantially homogenously disbursed within the polycarbonate. In FIG. 1, the boron nitride nanotubes comprise 5 wt % of each of the lenses 11 a, 11 b.

In the embodiment of the invention illustrated in FIG. 1, each of the lenses 11a, 11b is entirely fabricated from the composite material.

The eyeglass frame 12 comprises a number of parts, including rims 13a, 13b, a bridge 14, endpieces 15a, 15b, temples 161, 16b and temple tips 17a, 17b. In the embodiment of the invention illustrated in FIG. 1, the entire eyeglass frame 12 (with the exception of any hardware, such as hinges and screws) is fabricated from a composite material comprising a plurality of boron nitride structures dispersed within a base material, the boron nitride structures comprising one or more forms of crystalline boron nitride structures. Thus, in FIG. 1, the eyeglass frame and the lenses may be fabricated from the same material.

FIG. 2 illustrates a pair of eyeglasses 20 including lenses 21a, 21b according to an alternative embodiment of the present invention. In this embodiment, lens 21b is a single vision lens, meaning that the entire lens 21b is fabricated to be of the same prescription for vision correction. Alternatively, the lens 21b may be a non-prescription sunglass lens.

As with the lenses illustrated in FIG. 1, lens 21b is fabricated from a composite material comprising a plurality of boron nitride structures dispersed within a base material, the boron nitride structures comprising one or more forms of crystalline boron nitride structures. In this embodiment, the base material comprises polycarbonate, while the crystalline boron nitride structures comprise a mixture of boron nitride nanotubes and boron nitride nanosheets substantially homogenously disbursed within the polycarbonate. In FIG. 1, the crystalline boron nitride structures comprise 6 wt % of the lenses 21 b, while the boron nitride nanotubes comprise approximately 65 wt % of the crystalline boron nitride structures.

Lens 21a is a progressive lens, meaning that different regions of the lens 21a provide different forms of vision correction. In other words, lens 21a includes multiple prescriptions within the lens 21a and is commonly referred to as a multifocal lens. Specifically, region 22 of the lens 21a is configured to improve the distance vision of a wearer, region 23 of the lens 21a is configured to improve the near vision of the wearer, while region 24 is configured to improve the vision of the wearer at intermediate distances.

While each region 22, 23, 24 of the lens 21a may be fabricated from the same material as the surrounding region 25 of the lens 21a, it is envisaged that at least one of the regions 22, 23, 24 is manufactured from a different material to the surrounding region 25.

The material used in at least one of the regions may comprise different crystalline boron nitride structures to the other regions, different ratios of two or more crystalline boron nitride structures to the other regions and/or different quantities of crystalline boron nitride structures dispersed within the base material. In some embodiments of the invention, one or more regions may contain no boron nitride structures.

These variations may exist if, for instance, different quantities and/or ratios of boron nitride structures enhance the mechanical and/or vision correction properties of a specific region of the lens, or if the presence of certain quantities and/or ratios of boron nitride structures would have a detrimental effect on the mechanical and/or vision correction properties of a specific region of the lens.

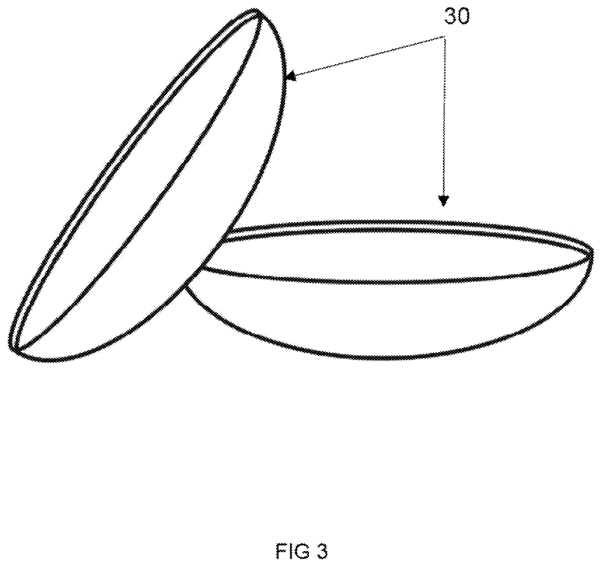

FIG. 3 illustrates contact lenses 30 according to an embodiment of the present invention. The lenses 11a, 11b are fabricated from a composite material comprising a plurality of boron nitride structures dispersed within a base material, the boron nitride structures comprising one or more forms of crystalline boron nitride structures

In this embodiment, the base material comprises hydrogel, while the crystalline boron nitride structures comprise boron nitride nanotubes substantially homogenously disbursed within the hydrogel. In FIG. 1, the boron nitride nanotubes comprise 6 wt % of each of the contact lenses 30.

In the embodiment of the invention illustrated in FIG. 3, each of the contact lenses 30 is entirely fabricated from the composite material.

In the present specification and claims (if any), the word ‘comprising’ and its derivatives including ‘comprises’and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A lens, the lens being at least partially fabricated from a composite material comprising a plurality of boron nitride structures dispersed within a base material, the boron nitride structures comprising one or more forms of crystalline boron nitride structures.

2. The lens according to claim 1 wherein the lens is an eyeglass lens or a contact lens.

3. The lens according to claim 1 wherein the entire lens is fabricated from the composite material.

4. The lens according to claim 3 wherein the boron nitride structures are substantially homogeneously dispersed throughout the entire lens.

5. The lens according to claim 1 wherein the composite material is applied as a coating to a surface of a base layer, the base layer being at least partially fabricated from glass or a polymeric material.

6. The lens according to claim 2 wherein, when the lens is an eyeglass lens, the base material comprises glass or polymeric material.

7. The lens according to claim 2 wherein, when the lens is a contact lens, the base material comprises hydrogel, silicone hydrogel or a relatively rigid silicone polymer.

8. The lens according to claim 1 wherein the lens is provided with shaped edges configured to be received and retained in an eyeglass frame.

9. The lens according to claim 8 wherein at least a portion of the eyeglass frame is fabricated from the same material as the lens.

10. The lens according to claim 1 wherein the composite material comprises between about 0.5 wt % and about 30 wt % boron nitride structures.

11. The lens according to claim 1 wherein the crystalline boron nitride structures boron nitride nanotubes, boron nitride ribbon, boron nitride wire, boron nitride sheets, boron nitride nanosheets, boron nitride nano wire and/or boron nitride nano ribbon.

12. The lens according to claim 1 wherein two or more forms of crystalline boron nitride structures are present.

13. The lens according to claim 12 wherein the two or more forms of crystalline boron nitride structures comprise a combination of boron nitride nanotubes, boron nitride wire, boron nitride ribbon and/or boron nitride nanosheets.

14. The lens according to claim 13 wherein each form of crystalline boron nitride structure comprises between 10% and 90% by weight or by volume of the total quantity of crystalline boron nitride structures.

15. An eyeglass frame, the eyeglass frame being at least partially fabricated from a composite material comprising a plurality of boron nitride structures dispersed within a base material, the boron nitride structures comprising one or more forms of crystalline boron nitride structures.

16. The eyeglass frame according to claim 15 wherein the one or more of the rims, bridge, endpieces, temples and temple tips of the eyeglass frame is fabricated from the composite material.

17. The eyeglass frame according to claim 15 wherein the eyeglass frame is configured to include one or more lenses.

18. The eyeglass frame according to claim 17 wherein the one or more lenses are formed integrally with the eyeglass frame.

19. The eyeglass frame according to claim 15 wherein one or more coating layers are applied to the eyeglass frame.

20. The eyeglass frame according to claim 19 wherein the one or more coating layers include scratch-resistant coatings, UV-resistant coatings, hydrophobic coatings and/or oleophobic coatings.
